(19) United States
(12) Patent Application Publication
(10) Pub. No.: US 2006/0283655 A1
(43) Pub. Date: Dec. 21, 2006

(54) Machine element

(76) Inventors: Thomas Motz, Herzogenaurach (DE); Matthias Dohr, Herzogenaurach (DE); Ernst Neuwirth, Herzogenaurach (DE); Manfred Kraus, Herzogenaurach (DE)

Correspondence Address: LUCAS & MERCANTI, LLP, 475 PARK AVENUE SOUTH, 15TH FLOOR, NEW YORK, NY, 10016, US

(21) Appl. No.: 10/570,926

(22) PCT Filed: Dec. 8, 2004
(86) PCT No.: PCT/EP04/09008

§ 371 Date: Mar. 21, 2006

(30) Foreign Application Priority Data
Sep. 6, 2003 (DE) 103 41 156.9

(51) Int. Cl. B62D 3/00

(52) U.S. Cl. 180/400

(57) ABSTRACT

The invention relates to a machine element which is provided, at least over part of its axial length, with first toothing (2.1) in the form of threads, running on its cylindrical lateral surface, for a threaded drive. This is distinguished in that the threads are produced by means of a continuous shape rolling process in the axial direction, as is known per se, the continuous shape rolling process being used in a partially continuous manner corresponding to the desired axial extent of the threads.

### FIELD OF THE INVENTION

The invention relates to a machine element which is provided, at least over part of its axial length, with first toothing in the form of threads, running on its cylindrical lateral surface, for a threaded drive.

### BACKGROUND OF THE INVENTION

Machine elements of this type are used in a variety of ways in different threaded drives, for example for performing transport, steering or braking functions.

A machine element of this type, embodied as a toothed rack for a rack-and-pinion steering system, is already known from WO 02/076808 A1. In a power steering system of this type, the manual steering input is assisted by an electric motor which has a drive connection to the toothed rack. The electric motor provides servo assistance to the conventional steering device where, in the usual way, a steering demand is transmitted from a steering wheel via a steering shaft to a pinion which acts on the toothed rack. A torque measuring device is installed between the steering shaft connection and the pinion. The torque measuring device senses the relative torque between the steering shaft connection and the pinion and controls the drive of the electric motor by means of an electronic module. A ball screw is used to convert the rotational movement of the electric motor into an axial movement of the toothed rack.

The toothed rack shown in FIG. 2 of the cited prior publication for the rack-and-pinion steering system of a motor vehicle has two toothed regions. It has both the flat toothing into which the toothed pinion engages and also toothing arranged on the lateral surface in the form of threads, into which the threaded nut, which is connected to the electric motor, engages.

It is not possible on account of the different surface geometries and the differently designed toothing regions to produce toothed racks of this type by continuous shape rolling and then simply cutting to a desired length.

### SUMMARY OF THE INVENTION

The object on which the invention is based is therefore that of cost-effectively producing a machine element of a generic embodiment of this type.

According to the invention, this object is achieved as claimed in the characterizing part of claim 1, in conjunction with its preamble, in that the threads are produced by means of a continuous shape rolling process in the axial direction, as is known per se, the continuous shape rolling process being used in a partially continuous manner corresponding to the desired axial extent of the threads.

This means that the relevant region of the machine element is placed at least between two rotating shape rolling tools which are initially spaced apart from one another and are subsequently moved towards one another. As it rotates between the rotating shape rolling tools the machine element obtains the negative shape of said rolling tools, and is moved little by little through the shape rolling tools in the axial direction. Once the desired functional length of the machine element has been provided with threads, the shape rolling tools are moved away from one another and the machine element can be removed, a run-in region and a run-out region of the threads being present for production reasons.

The advantage of the solution according to the invention is that machine elements of this type having partial function areas can be produced in a cost-effective manner by means of this non-cutting shaping process. In particular, no cutting pre-working or re-working processes are required in the toothed region. The axial extent of the thread profile can also be limited to the functionally required length by means of this partially continuous shape rolling process, and this has an effect in particular on the stability of machine elements of low diameter. The partially continuous shape rolling process has the additional advantage that, in contrast to shape rolling using the single-pass process, a significantly lower tool width is required and hence lower shaping forces are necessary. It is also advantageous that better toothing quality can be obtained using the partially continuous shape rolling process than when using the single-pass process.

Advantageous embodiments of the invention are described in the sublaims.

Claim 2 provides that the machine element is provided with second toothing which, according to claim 3, is of a flat form.

In a refinement of the invention, claim 4 provides that the machine element is embodied as a single-part toothed rack for a rack-and-pinion power steering system having an electric motor for a motor vehicle, which power steering system is operatively connected to steered wheels, a toothed pinion, which is connected to a steering wheel, engaging in the first toothing of the toothed rack and, in order to convert the rotational movement of the electric motor into an axial movement of the toothed rack, the threaded drive being provided, whose threaded shaft, which has threads, is surrounded by a threaded nut, so that rollers arranged between said threaded shaft and said threaded nut roll both in the threads of the threaded shaft and in threads of the threaded nut.

The invention is explained in more detail on the basis of the following exemplary embodiment of a toothed rack for a rack-and-pinion steering system of a motor vehicle.

### BRIEF DESCRIPTION OF THE DRAWINGS

In the drawings:

FIG. 1 shows a side view of a toothed rack having a threaded drive,

FIG. 2 shows a perspective illustration of the toothed rack,

FIGS. 3a to 3c show a schematic illustration of the profile of a toothed rack and

FIG. 4 shows a section of a rack-and-pinion power steering system for a motor vehicle.

### DETAILED DESCRIPTION OF THE DRAWINGS

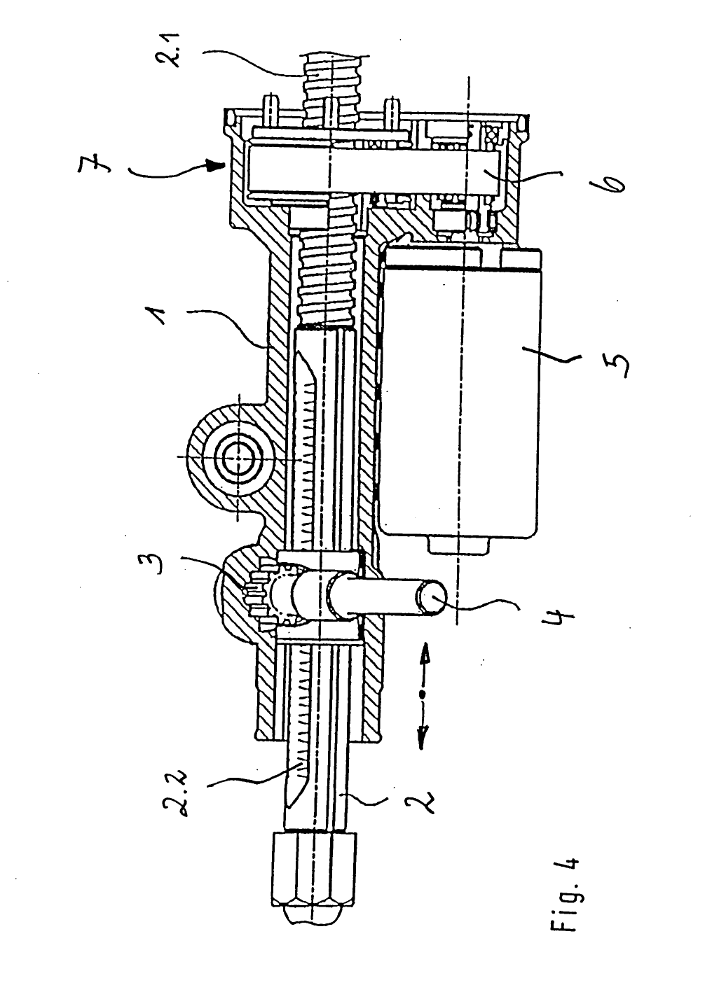

As can be seen from FIG. 4, a toothed rack 2 is mounted in a housing 1 so as to be longitudinally displaceable and is connected, in a manner which is not illustrated, at the left- and right-hand sides to a steering linkage which in turn is operatively connected to wheels (likewise not illustrated) which are to be steered. The toothed rack 2 has a first toothing 2.1 whose threads are arranged on the lateral surface of the toothed rack 2. As can be seen, the first toothing 2.1 runs only over a partial axial region of the toothed rack 2. The power steering system also comprises an electric motor 5 which is connected to a threaded drive 7 by means of a belt 6. The toothed rack 2 also comprises a second flat toothing 2.2 into which a toothed pinion 3 engages which is connected to a steering shaft 4, which in turn is moved by a steering wheel (likewise not illustrated).

If the toothed pinion 3 is moved by the driver, via the steering wheel and the steering shaft 4, to the right or the left in the circumferential direction, the relative torque between the steering shaft 4 and the toothed pinion 3 is sensed by a torque measuring device installed in between the latter. The torque measuring device controls the drive of the electric motor 5, which is connected to the threaded drive 7 by means of the belt 6. When the threaded nut of the threaded drive 7 rotates, the toothed rack 2 is moved corresponding to the arrows to the right or to the left in the axial direction, so that the desired steer angle of the wheels is set.

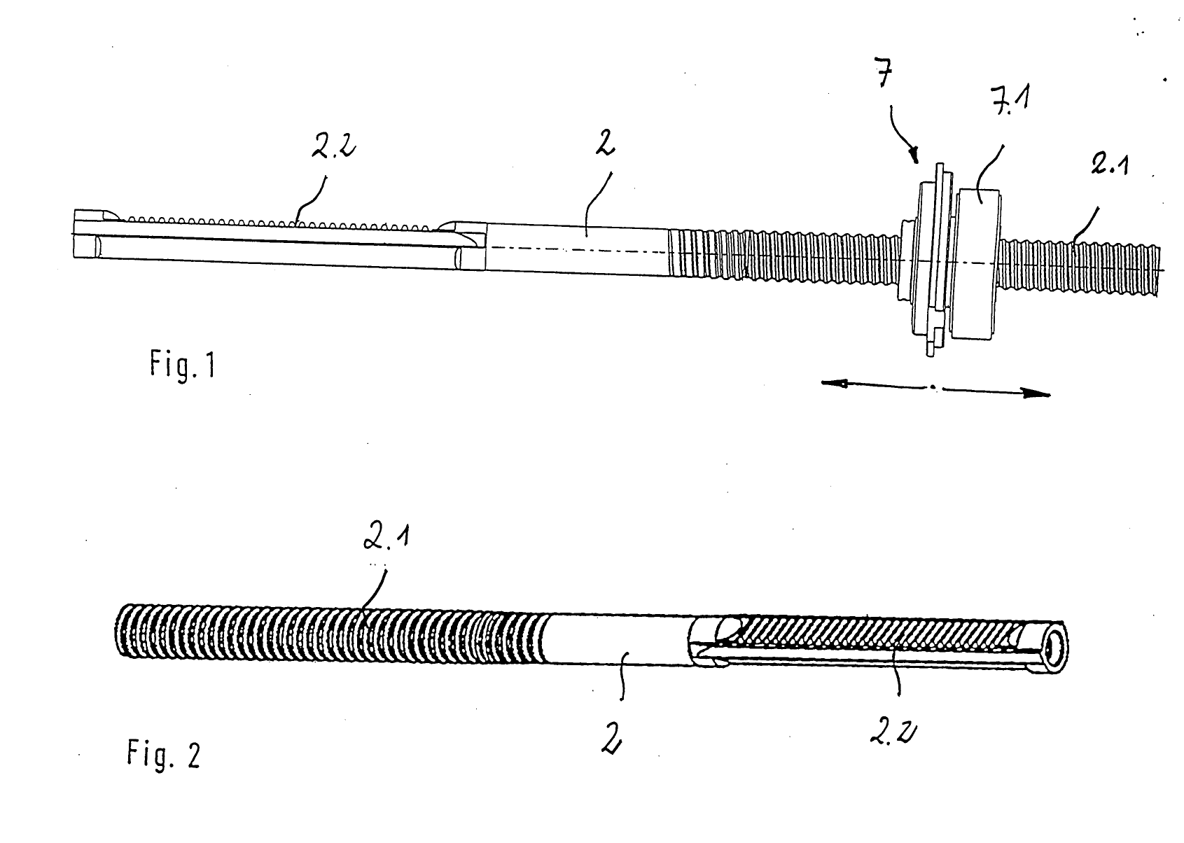

The toothed rack 2 illustrated in FIGS. 1 and 2 having the first circumferential toothing 2.1 in the form of threads arranged on the lateral surface and the second flat toothing 2.2 shows that, when the belt pulley 7.1 of the spatially fixed threaded drive 7 rotates, the toothed rack 2 is moved in the axial direction according to the direction of rotation.

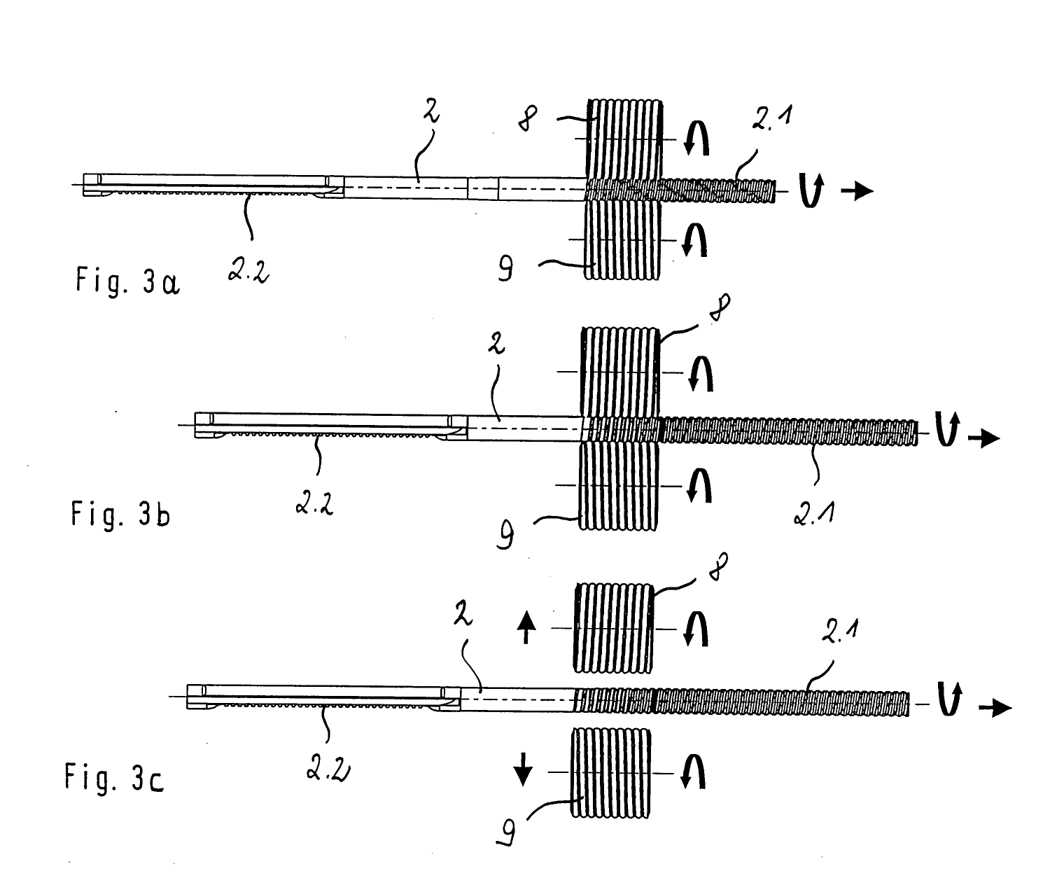

As the schematic illustrations in FIGS. 3a, 3b and 3c show, at least two shape rolling tools 8, 9 are provided which are spaced apart from one another with their axes parallel. The shape rolling mill 8 is held rotatably on a slide (not illustrated), while the shape rolling mill 9 is rotatably mounted on another slide (likewise not illustrated). The two slides can be moved toward one another and moved away from one another so that the size of the rolling gap can be set. The two shape rolling tools 8, 9, which are driven at the same speed, rotate in the same direction, as indicated by their rotational direction arrows. As a result, the continuous shape rolling process causes the toothed rack 2 to rotate in the opposite direction. In this cold rolling process, the toothed rack 2 is now placed into the working space, that is to say into the closed rolling gap between the two shape rolling tools 8, 9, by means of a suitable supply device (not illustrated). When the shape rolling tools 8, 9 rotate, the toothed rack 2 is likewise set in rotation, and is pulled little by little through the two shape rolling tools 8, 9 in the axial direction. As can be seen in FIGS. 3a to 3c, the toothed rack 2 is moved through the shape rolling tools 8, 9 in the direction of the arrow until the desired functional length of the toothed rack 2 is provided with the circumferential first toothing 2.1. This functional length is then larger, as seen in the axial direction, than the axial width of the shape rolling tools 8, 9.

### LIST OF REFERENCE SYMBOLS

1 Housing
2 Toothed rack
2.1 First toothing
2.2 Second toothing
3 Toothed pinion
4 Steering shaft
5 Electric motor
6 Belt
7 Threaded drive
8 Shape rolling tool
9 Shape rolling tool

1. A machine element which is provided, at least over part of its axial length, with first toothing in the form of threads, running on its cylindrical lateral surface, for a threaded drive, characterized in that the threads are produced by means of a continuous shape rolling process in the axial direction, as is known per se, the continuous shape rolling process being used in a partially continuous manner corresponding to the desired axial extent of the threads.

2. The machine element as claimed in claim 1, characterized in that it is provided with second toothing (2.2).

3. The machine element as claimed in claim 2, characterized in that the second toothing (2.2) is of a flat form.

4. The machine element as claimed in claim 1, characterized in that it is embodied as a single-part toothed rack (2) for a rack-and-pinion power steering system having an electric motor (5) for a motor vehicle, which power steering system is operatively connected to steered wheels, a toothed pinion (3), which is connected to a steering wheel, engaging in the second toothing (2.2) of the toothed rack (2) and, in order to convert the rotational movement of the electric motor (5) into an axial movement of the toothed rack (2), the threaded drive (7) being provided, whose threaded shaft, which has threads, is surrounded by a threaded nut, so that rollers arranged between said threaded shaft and said threaded nut roll both in the threads of the threaded shaft and in threads of the threaded nut.
